(19) United States
(12) Patent Application Publication
(10) Pub. No.: US 2006/0019012 A1
(43) Pub. Date: Jan. 26, 2006

(54) Dysphagic dietary treatment

(76) Inventors: Madonna Novotny, Coon Rapids, MN (US); Vicky Pavcik, Coon Rapids, MN (US)

Correspondence Address: Angenehm Law Firm, Ltd., P.O. Box 48755, Coon Rapids, MN, 55448-0755, US

(21) Appl. No.: 10/895,702

(22) Filed: Jul. 21, 2004

(51) Int. Cl. A21D 10/00

(52) U.S. Cl. 426/549

(57) ABSTRACT

Disclosed is a method for the manufacturing of a formable food for people afflicted with dysphasia. In carrying out the invention one measures bread crumbs, cornstarch, powdered milk, sugar, a first portion water mixing ingredients together; bring water to boil; dissolve gelatine in a second portion of cold water; add the dissolved gelatine to the boiling water; add to the bread crumbs/water mixture and pour ¼ cup of said mixture into paper baking cup lined muffins tins; let set.

### FIELD OF THE INVENTION

This invention relates to the medical field and more particularly to food for those afflicted with dysphagia.

### BACKGROUND OF THE INVENTION

Those afflicted with dysphagia have a difficult time swallowing whole food. Foods to “thin”, e.g., viscous, can cause the patient to aspirate, taking the liquid into their lungs. Foods to “thick” or solid pose a serious choking hazard. The appropriate thick/thin balance needs to be found with respect to each food and beverage provided to a dysphagic patient.

Dysphagia is an infliction of varying degrees. The medical field currently identifies four different levels of severity, for treatment purposes, although it is generally understood that these are not levels, but rather points along a continuim used for regulating dietary treatment.

Those with the most serious infliction, level 1 dysphagic patients, need all foods to be in a liquid form, having a consistency at or about that of honey. To achieve this level of precision in balancing the thickness/thinness all foods are pureed, adding liquids where necessary. For instance, a slice of bread is pureed, perhaps with milk, and served in a bowl. Eaten with a spoon, a ham sandwich lacks the enjoyment not inflicted persons experience. This methodlogy, while the standard in the industry, fails because some patients find their favorite foods unpalatable and unattractive appearance. Not surprisingly, these patients commonly have severe weight loss problems, finding themselves taking dietary supplements and in the most severe cases, being fed via a tube.

Some work has been done in the area of meats, which lack porousity. U.S. Pat. No. 6,458,395 (Mitsu) discloses a gelatinous food product including water, saccharide, lipid, protein, organic emulfying agent, organic acid salt, gelling agent as a food product for patients dyshagia. U.S. Pat. No. 6,607,776 (Howard et al.) discloses a protein enhanced gel generally in the form of a dessert gel containing soy protein isolate, soy protein concentrate, whey and sodium caseinate. U.S. Pat. No. 6,461,589 (Robbins) discloses a gelled whey protein, a carbohydrate source, minerals and vitamins. Meat is perhaps the food group that is to be consumed the least and generally is non-pourous.

Perhaps the food group that is to be consumed the most is grains, such as that found in bread. What is needed is a dysphagic deitary food based upon breads. This food should be transformable into a variety of recipes, including main courses, such as sandwiches, pizza, and the like and in desert forms such as doughnuts, cakes, and other pastries. This food should formable such that it can be presented in a standard form for the food type, e.g. a pizza appears as a pizza not a slurry served in a bowl. The food should also have a thickness/thinness balance within the bounds that dysphagic patients can consume.

### SUMMARY OF THE INVENTION

The present invention relates to a method for manufacturing of formable food for dysphagia. The method includes measuring bread crumbs, corn starch, powder milk, cup sugar and mixed. Water is brought to a boil. Gelatin is dissolved in cold water. The dissolved gelatin is added to the boiling water. The bread crumb mixture is added to the boiling water and poured into a mold pan and let set. The present invention can be used beneficially with all levels of dysphagia patients.

Advantageously, the present invention is based upon breads, a major source of grains.

As yet a further advantage, the present invention, is formable into standard forms represented by the food, providing psychological support to those suffering from dysphagia.

As still yet a further advantage, the present invention is incorporatable into a wide variety of recipes, including main courses and deserts.

As still yet another advantage, the food is of a precision thickness/thinness balance that the food is consumable by those with the most severe infliction of dysphagia.

That is the present invention advantageously is designed for Level I (Pureed Diet), II (Semi-solid Pureed Diet), III (Soft Diet), and IV (Soft Diet) Dysphagia Diets provides food that is of a consistency that will facilitate ease in chewing and swallowing. The food is for use in the Level V (Regular Transitional Diet) to provide a transition between the Dysphagia IV and Regular Diet. The Level I, II, III, IV and V Dysphagia Diets are for patients with mechanical or pathological impairment of chewing or swallowing.

These advantages and additional advantages are found throughout the description and are discernable from the description to those of ordinary skill in the art.

### DEFINITIONS

The following definitions are intended to apply throughout the description and claims:

Level I Dysphagia (or dysphagic diet)—are those patients who must have a precise balance of thickness and thinness of food. Suitable foods are typically of a blended/pureed consistency. All beverages must be of a syrup/nectar, honey consistency with no thin liquids allowed. Any thin liquids (i.e. —water, juices, etc) are to be thickened to a syrup consistency. Soups (broth or cream) are allowed if they, too, are of a honey consistency with no whole pieces of any kind added.

Level II Dysphagia (or dysphygic diet)—are those patients that can have a slightly broader flexibility in the balance of thickness and thinness of food as compare to Level 1 and more restrictive than that of Level 3. Specifically, food is typically blended/pureed or semi-solid such as pureed bread, crackers soaked in milk with thin liquid drained off; meats and fish ground; fruits cooked and diced; vegetables, including potatoes, fully cooked and mashed or finally diced. Fruits can be canned, well-cooked and diced or diced bananas.

Level III Dysphagia (or dysphagic diet)—are those patients that can have a slightly broader flexibility in the balance of thickness and thinness of food as compare to Level 2 and more restrictive than that of Level 4. Typical diets include those items of Level II with the additions of bread or toast with soft crust, pancakes/French toast soaked in syrup, plain muffins or doughnuts. Pumpkin pie, cheesecake (both without crusts), soft cakes and cookies, candy bars. Meats can be ground, baked fish, canned salmon or tuna, ground meat casseroles and chopped luncheon meats.

Level IV Dysphagia (or dysphagic diet)—are those patients that can have a slightly broader flexibility in the balance of thickness and thinness of food as compare to Level 3 and more restrictive than that of Level 5. Typical diets include chopped meat rather than ground or pureed, and the addition of crushed pineapple and fruit cocktail added to the fruit list. Soups are made the same in I, II, III and IV, but in Level IV small well-cooked pieces of vegetable may be added. Chili may have well-cooked beans. Meats are of the same consistency as Level III. At this level, fruit crisps and cherry layer dessert is added as is jelly beans, gum drops, marshmallows and chewing gum. The beverages are still of the thickened consistency.

Level V Dysphagia (or dysphagic diet)—are those patients that can have a slightly broader flexibility in the balance of thickness and thinness of food as compare to Level 4 and more restrictive than that of normal diets. This is the transitional diet prior to a regular diet. This food can be easily chewed and swallowed with all raw fruits and vegetables still omitted together with any fruit or vegetable with tough membranes, small seeds or skins. All meat is allowed as well as all soups. Breads and cereals containing whole grain flour, bran, nuts, raisins or seeds are still avoided. Also avoided at this level are potato chips, any foods containing coconut, dried fruits, nuts or seeds; chunky peanut butter, popcorn, olives, relish or pickles.

Water—water is intended to have a broader meaning than H₂O. Water means water based liquids, having a viscosity similar to that of H₂O, including but not limited to milk, fruit juices, tea, coffee, inoculated drinks such as energy drinks, sport drinks, etc.

### DETAILED DESCRIPTION OF THE PRESENT INVENTION

This invention relates to a method for the manufacturing of food formable for people with Level 1 dysphagia. In carrying out the invention in its simplest form one measures 30% to 44% by volume, bread crumbs; 54% to 68% by volume, water; to 2% by volume, powdered gelatine. Dry ingredients used in bread such as powdered milk and sugar may be partially substituted for bread crumbs. Starch may be used to thicken access water and/or to cause the solution to fully thicken in less time.

The above percentages are the preferred ranges for level 1 disphagic patients. With the aid of starch or other thickener, the water concentration can tend higher and would be considered an equivalent. With the aid of an absorbent inhibitor, such as shortening, water concentrations can tend lower and would be considered an equivalent. More tolerant levels of disphagic patients can consume foods with broader ranges of bread crumbs and water. When the water concentration is high, the mixture tends to set too slow for commercial application and when the water concentration is low, the mixture tends to become to sticky, e.g. thick.

The most preferred ratio of bread crumbs to water to gelatine is 36:62:2, which yields a presetting thickness approximate to that of the first preferred embodiment described below. Once set, the mixture appears to have a structure most similar to that of bread.

The mixture is allowed to set at which point it appears as a solid bread structure, substantially distinct in appearance as bread that may otherwise be served to dysphagic patients in a bowl to be eaten with a spoon. The solid bread structure, crumbs or disintegrates, representative of the viscosity of thickened liquids, when placed in the mouth of a Level I dysphagic patient, and is suitable for consumption by such patient.

### The Preferred Embodiments

### EXAMPLE I

PUREED BREAD (This is the base recipe used in all the following recipes)

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
Poured into a jelly roll pan and let set.

CASE STUDY 1 This recipe has been tested on people with dysphagia and found to be palatable, appetizing and pleasing to the eye as well as nourishing. A ninety eight year old female resident with dementia was resistive to feeding, eating very slowly, taking up to one hour per meal. In November, 2002, her weight was 103 lbs and had declined. She was started on dessert items made according to the present invention and is now 100 years old and weighed 118 lbs as of February, 2004.

CASE STUDY 2 A sixty one year old male with severe retardation weighed in at 126 lbs in November, 2002. With the present invention as part of his pureed diet, he weighed 137 lbs as of February, 2004.

CASE STUDY 3 A ninety two year old female with Alzheimers, weighing 84 lbs in November 2002, was very selective of her foods, therefore eating very little. Her goal was to reach 100 lbs and to be able to go home. She was started on the present invention dessert items and her appetite perked right up. She returned to her home weighing 103 lbs.

CASE STUDY 4 A ninety one year old female with extreme confusion was admitted at 130 lbs and would not eat most of her meal. Her weight dropped to 124 lbs in November, 2002. She would eat desserts according to the present invention and by March 2003 she was up to 140 lbs. By then her overall meal intake had improved which indicates that the present invention invigorated her appetite and interest in food.

CASE STUDY 5 A ninety year old resident with senile dementia refused to eat a pureed diet with thickened liquids. With the present invention added to her menu, she went from 118 lbs in April, 2003, to 136 lbs as of February, 2004.

CASE STUDY 6 A forty eight year old resident with Multiple Sclerosis was admitted, weighing in at 200 lbs and refused to eat anything on his mechanical soft diet. He was quite non-verbal and immobile at that time. He was offered the present invention along with his pureed diet with thickened liquid, jump starting his appetite so his meal intake was greatly improved. He now weighs 204-206 lbs, showing no further weight loss. He is verbal, up and about, and frequently thanks the kitchen staff, saying, “Thank you” and “Good”!

### EXAMPLE II

BANANA CHOCOLATE MUFFIN

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
Added 2 teaspoons of banana extract and ½ cup chocolate syrup.
Lined muffin tins with paper baking cups
Filled muffins tins with ¼ cup mixture. Let set.
Garnished with chocolate syrup and whipped cream.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE III

MINT CHOCOLATE MUFFIN

Measured the following:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring till mixed
Added 2 teaspoons of mint extract and ½ cup chocolate syrup.
Lined muffin tins with paper baking cups
Prepared bread mix. Added mint extract and chocolate syrup
Mixed well, filled muffin tins with ¼ cup mixture. Let set.
Garnished with chocolate syrup and whipped cream

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE IV

CHOCOLATE CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups of water to a boil.
Poured gelatine into 1 cup cold water stirring until dissolved.
Added the dissolved gelatine to the boiling water
2 pounds of chocolate pudding
½ cup modified corn starch
½ cup sugar
Chocolate syrup
Combined the pudding and corn starch, mixing well.
Lined muffin tins with paper baking cups
Prepared bread mix. Added sugar stirring well
Filled muffin tins with ¼ cup of mix. Let set
Removed paper from muffin and placed in center of plate
Poured ¼ cup pudding mixture over muffin
Taking a second muffin, placed it on top of pudding
Garnished with 1 tablespoon of pudding, whipped cream and chocolate syrup.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE V

LEMON CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 pounds lemon pudding
½ cup modified corn starch
½ cup sugar
Lemon Sauce
Mixed pudding and cornstarch, stirring well
Lined muffin tins with paper baking cups
Prepared bread mix add sugar stir well
Filled muffin tins with ¼ cup of mixture. Let set
Removed paper from muffin and placed in center of plate
Poured ¼ cup pudding mix on top of muffin
Taking a second muffin, placed it on top of first muffin
Garnished with 1 tablespoon of pudding, whipped cream and lemon sauce.

The mixture, once set, appeared as a solid crushable structure of sufficient character to be consumed by level 1 dysphagic patients. This recipe has been tested on people with dyshagia and found to be palatable, appetizing and pleasing to the eye as well as nourishing.

### EXAMPLE VI

RASPBERRY CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 pounds pureed raspberries
Modified corn starch
½ cup sugar
Raspberry Sauce
Thickened pureed raspberries with corn starch to pudding consistency.
Lined muffin tins with paper baking cups
Prepared bread mix adding the sugar and stirring well
Filled muffin tins with ¼ cup of mixture. Let set
Removed paper from muffin and placed in center of plate
Poured ¼ cup raspberry pudding over muffin
Taking a second muffin, placed it on top of first muffin
Garnished with 1 tablespoon of raspberry pudding, whipped cream and raspberry sauce.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE VII

BANANA CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring till mixed
2 pounds banana pudding
½ cup modified corn starch
½ cup sugar
White chocolate Sauce
Lined muffin tins with paper baking cups
Prepared bread mixture and added sugar stirring well
Filled muffin tins with ¼ cup of mixture. Let set
Removed paper from muffin and set in center of plate
Poured ¼ cup pudding mixture over muffin
Placed a second muffin on top of first muffin
Garnished with 1 tablespoon of pudding, white chocolate sauce and whipped cream.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE VIII

BLUEBERRY CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 pounds pureed blueberries
Modified corn starch
½ cup sugar
Blueberry sauce
Thickened the blueberry puree with the cornstarch until it is of pudding consistency
Lined muffin tins with paper baking cups
Prepared bread mixture, adding the sugar and stirring well
Filled muffin tins with ¼ cup of mixture. Let set
Removed paper from muffin and set in center of plate
Poured ¼ cup pudding over muffin
Placed a second muffin on top of the first
Garnished with 1 tablespoon of blueberry, whipped cream and blueberry sauce.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE IX

BUTTERSCOTCH CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 pounds butterscotch pudding
½ cup modified cornstarch
½ cup sugar
Added the cornstarch to the pudding mixture, stirring well
Lined muffin tins with paper baking cups
Prepared bread mixture, adding the sugar and stirring well
Filled muffin tins with ¼ cup of mixture. Let set
Removed paper from muffin and place in center of plate
Poured ¼ cup pudding mixture on top
Placed a second muffin on top of the first
Garnished with 1 tablespoon of pudding and whipped cream.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE X

MINT CHOCOLATE MUFFIN

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 teaspoons mint extract
½ cup chocolate syrup
Prepared above bread mixture, adding the mint extract.
Lined muffin tins with paper baking cup
Filled muffin tins with ¼ cup mixture. Let set.
Garnished with chocolate syrup and whipped cream.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE XI

STRAWBERRY CRUSH

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
2 pounds pureed strawberries
Modified cornstarch
½ cup sugar
Strawberry sauce
Thickened the pureed strawberries with the cornstarch until a pudding consistency
Lined muffin tins with paper baking cups
Prepared bread mix, adding sugar and stirring well
Filled muffin tins with ¼ cup of mixture. Let set
Removed paper from muffin and place in center of plate
Poured ¼ cups pudding mixture over muffin
Placed a second muffin on top of the first muffin
Garnished with 1 tablespoon of strawberry pudding, whipped cream and strawberry sauce.

The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE XII

BANANA MUFFIN

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Poured gelatine into 1 cup cold water stirring until dissolved.
Added the dissolved gelatine to the boiling water, mixing well.
Poured in bread crumb mixture stirring until mixed
Banana extract
⅔ cup sugar
Lined muffins tins with paper baking cups
Prepared bread mixture adding the sugar and banana extract.
Filled muffin tins with ¼ cup mixture. Let set.
Garnished with whipped cream.
The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

### EXAMPLE XIII

BLUEBERRY MUFFINS

The following ingredients were measured:
2½ cups bread crumbs
4 tablespoons corn starch
2 tablespoons powder milk
¼ cup sugar
5 cups water
2 oz gelatine
Mixed bread crumbs, corn starch, powder milk, sugar. Set aside.
Brought 4 cups water to a boil
Added gelatine to 1 cup cold water stirring until dissolved.
Added the dissolved gelatine to the boiling water, mixing well.
Poured in bread crumb mixture stirring until mixed
½ cup sugar
½ cup pureed blueberries
Lined muffin tins with paper baking cups
Prepared bread mixture, adding sugar and blueberries, stirring well
Filled muffin tins with ¼ cup mixture. Let set
Garnished with whipped cream.
The mixture, once set, appeared as a solid crushable structure of sufficient character to be consumed by level 1 dysphagic patients. This recipe has been tested on people with dysphagia and found to be palatable, appetizing and pleasing to the eye as well as nourishing.

We claim:

1. A method for manufacturing of formable food for dysphagic patients comprising:
measuring 30 to 44% by volume of bread crumb mixture; 54% to 68% parts by volume of water a portion of which is cold and a portion of which is at approximately boiling temperature and approximately 2% by volume, gelatin;
dissolve gelatin in cold water;
disperse the dissolved gelatin in the boiling water and bread crumbs; and
pour dispersion in mold and set into a jell-like form.

2. The method for manufacturing of formable food for dysphasic patients of claim 1 wherein the bread crumb mixture consists of bread crumbs.

3. The method for manufacturing of formable food for dysphasic patients of claim 1 wherein the bread crumb mixture includes bread crumbs and at least one member of the group consisting of sugar and powdered milk.

4. The method for manufacturing of formable food for dysphasic patients of claim 1 further comprising the step of incorporating starch into the dispersion.

5. The method of claim 4 wherein the starch is modified starch.

6. The method for manufacturing of formable food for dysphagic patients of claim 1 further comprising the step of incorporating a flavoring amount of banana extract and chocolate syrup into the dispersion.

7. The method for manufacturing of formable food for dysphagic patients of claim 1 further comprising the step of incorporating a flavoring amount of mint abstract and chocolate syrup into the dispersion.

8. The method for manufacturing of formable food for dysphagic patients of claim 1 further comprising the step of incorporating in the resulting mixture a flavoring amount of banana pudding, sugar, and white chocolate sauce.

9. The method for manufacturing of formable food for dysphagic patients of claim 1 further comprising the step of incorporating in the resulting mixture a flavoring amount of pureed raspberry, sugar and raspberry sauce.

10. The method for manufacturing of formable food for dysphagic patients of claim 1 further comprising the step of incorporating in the resulting mixture a flavoring amount of banana pudding, sugar, and white chocolate sauce.

11. The method for manufacturing of formable food for dysphagic patients of claim 1 further comprising the step of incorporating in the resulting mixture a flavoring amount of butterscotch pudding and sugar.

12. The method for manufacturing of formable food for dysphagic patients of claim 1 further comprising the step of incorporating in the resulting mixture a flavoring amount of mint extract and chocolate syrup.

13. The method for manufacturing of formable food for dysphagic patients of claim 1 further comprising the step of incorporating in the resulting mixture a flavoring amount of pureed strawberries and sugar.

14. The method of claim 1 wherein the ratio of cold water to gelatine is ½ cup cold water per ounce of gelatine.

15. A method for manufacturing of formable bread for dysphagic patients, said method comprising:
measuring 30% to 44% by volume bread crumbs, powder milk, and sugar combination;
providing 58% to 64% by volume water a portion of which is cold and a portion of which is hot;
dissolving approximately 2% by volume gelatine in the cold water;
blending the bread crumb, powdered milk and sugar combination, starch, hot water and cold water with gelatine combination into a mixture;
pouring the mixture into a mold pan and let set.

16. A method for manufacturing of formable bread for dysphagic patients, said method comprising:
measuring the following ingredients:
2½ cups bread crumbs
4 tablespoons corn starch
2 tablespoons powder milk
¼ cup sugar
5 cups water
2 oz gelatine;
mixing bread crumbs, corn starch, powder milk and sugar;
bringing 4 cups water to a boil
pouring gelatine into 1 cup cold water stirring until dissolved;
adding the dissolved gelatine to the boiling water, mixing well;
pouring in bread crumb mixture stirring until mixed;
pouring mixture into a pan and let set.
